(19) United States
(12) Patent Application Publication
(10) Pub. No.: US 2025/0215521 A1
(43) Pub. Date: Jul. 3, 2025

(54) Method for producing a metal product

(71) Applicant: SMS group GmbH, Mönchengladbach (DE)

(72) Inventors: Thomas HASCHKE, Bad Berleburg (DE); Dietmar HOPPE, Hilchenbach (DE); August SPROCK, Düsseldorf (DE)

(73) Assignee: SMS group GmbH, Mönchengladbach (DE)

(21) Appl. No.: 18/852,443

(22) PCT Filed: Mar. 20, 2023
(86) PCT No.: PCT/EP2023/056984

§ 371 Date: Sep. 28, 2024

(30) Foreign Application Priority Data
Apr. 1, 2022 (DE) 10 2022 203 248.9

(51) Int. Cl. C21D 11/00; B21B 37/00; B22D 46/00; C21D 8/02; C23G 1/00

(52) U.S. Cl. CPC C21D 11/00; B21B 37/00; B22D 46/00; C21D 8/0221; C21D 8/0247; C23G 1/00

(57) ABSTRACT

A method relates to producing a metal product in a plurality of successive process steps, each having an assigned set of manipulated variables. The method includes measuring an actual property of the metal product at a measurement site, at one but a last of the process steps; comparing the actual property at the measurement site with a predefined target property; determining an adjustment deviation; and adjusting the actual property to the target property by suitably varying at least one of the manipulated variables. The target property for the metal product at the output of the last of the successive process steps is predefined; and the at least one manipulated variable for adjusting the actual property of the metal product is selected from a set of manipulated variables which is assigned to at least one process step which comes after the process step to which the measurement site is assigned.

### CROSS-REFERENCE TO RELATED APPLICATION

This application is a national stage application, filed under 35 U.S.C. § 371, of International Patent Application PCT/EP2023/056984, filed on Mar. 20, 2023, which claims the benefit of German Patent Application DE 10 2022 203 248.9, filed on Apr. 1, 2022.

### BACKGROUND

The disclosure relates to a method for producing a metal product in a plurality of successive process steps in a steel mill. Known process steps with such a production process are, for example, the blast furnace, a casting machine, a hot-rolling mill, etc. The individual process steps are in each case assigned a number of manipulated variables that can be used to influence the method in the individual process steps.

The method aims to achieve a predefined target property for the metal product at the end of the last of the successive process steps. The final process step in each case depends on the metal product to be produced.

The use of process models to (pre-) control or adjust individual process steps of the specified process steps or a plurality of successive process steps has been known in the prior art for many years. Examples of this include a stitch plan computer for roughing and finishing mills or process models for controlling a cooling section. For the best possible process control, the process models used in the production process of a rolled end product can be coupled with one another via a process control system, for example. This makes it possible to exchange relevant process variables between the individual models and thus increase the predictive accuracy of the individual process models, for example.

An important mechanical property of a metal product is, for example, the grain size, because it influences both the forming behavior of the metal product during rolling, in particular during hot rolling, and the transformation behavior of the metal product in a subsequent cooling section. The exact determination of the grain size is of particular importance. A well-known method for accurately measuring the grain size in a metal strip is the so-called “laser ultrasonic method” (LUS method). It is used at various positions within the successive process steps, in order to observe the microstructure/microstructure development.

The “microstructure” property is just one example of a large number of properties of the metal strip that are traditionally measured in a process step of the production process, but which then have no influence on upstream and/or downstream process steps in the production process for achieving a predefined target property at the output of a final process step in each case. The last process step is the process step at the output of which the metal product is delivered as required. In particular, if an actual property deviates from an assigned target property, in particular in the case of a deviation of the actual microstructure from a target microstructure, no corrections are traditionally carried out to the settings of the individual process steps during the passing through of the metal strip.

### SUMMARY

The disclosure is based on the object of further developing a known process for producing a metal product in such a way that the setting of desired target properties of the metal strip at the output of the last process step is made possible within narrower tolerances than was previously possible in the prior art.

This object is achieved by the method as disclosed and claimed. This method is characterized in that the target property for the metal product is predefined at the output of the last of the successive process steps and in that the at least one manipulated variable for adjusting the actual property of the metal product is selected from a set of manipulated variables that comes after at least one process step to which the measurement site is assigned.

The last process step is the process step at the output of which the metal product with the desired target property is delivered. The method presupposes the existence of at least two successive process steps.

The term “process step” refers to a separate plant and is expressly distinguished from sub-processes within a plant. For example, the process step of hot rolling can be followed by the process step of pickling. The process step of hot rolling can be subdivided into various sub-processes such as heating and cooling steps, separating steps, forming steps, etc.

The term “metal strip” is used uniformly for the entire production process in each case for all process steps. That is, there is no conceptual distinction regarding which process step the metal strip is currently passing through in each case and how the metal strip is treated there in each case.

The terms “upstream” and “downstream”/“following” mean upstream and downstream in the direction of production in relation to the respective process step.

With the aid of the present invention, it is advantageously possible to extend previously known setting models, which are traditionally used to determine the setting of manipulated variables in individual process steps, in such a way that the manipulated variables can now also be determined with regard to new target properties of the metal product. This gives plant operators an additional opportunity to design the process control with regard to increased production reliability and increased safety when setting the target properties of the metal product. This represents a direct competitive advantage in view of the ever-increasing demands placed on the products produced in the individual process steps of a steel mill, for example on the part of the automotive industry.

The determined actual properties of the metal product/of its preliminary products are used in a process model for the control and/or adjustment of, for example, the complete production process, from the melting and casting process to hot rolling and final cooling in a cooling section and beyond. In particular, the measured actual properties are used by the process model in order to derive the optimum manipulated variables for the individual process steps with regard to the desired target properties. The optimized manipulated variables determined in this way advantageously lead to an improved setting of the final target properties of the hot-rolled metal product, i.e. to a setting of its target properties within narrower tolerances than was possible in the prior art.

The variation of manipulated variables claimed here in process steps following the process step with the measurement site offers the advantage that an already produced metal product that does not yet have the desired target property at the measurement site can possibly still be saved by varying the manipulated variables in the subsequent process steps with regard to attaining the target properties after the last production step.

In accordance with a first exemplary embodiment, the term “actual property of the metal strip” is defined. This can be either an actual material property, an actual strength parameter or an actual geometric property of the metal strip.

The examples of individual actual properties listed in claim 2 do not claim to be exhaustive.

The terms “actual property” and “target property” can each be based on the same property in each case. However, this is by no means mandatory; rather, the terms “actual property” and “target property” can also mean different properties. This applies in particular if a target property can be derived/can be calculated from another actual property, and vice versa. In these cases, the present method assumes that modules are present in the respective control loops, in particular in the process models used, in order to convert one property into the other property. For example, a certain measured grain size as an actual material property allows conclusions to be drawn about the resulting strength as the target property.

In accordance with an exemplary embodiment, the method for producing the metal product comprises at least some of the following process steps, for example:

Melting, casting preferably including strand guiding, hot rolling, pickling, cold rolling, heat treatment, surface coating, temper rolling, stretch leveling. The aforementioned process steps are preferably executed one after the other in the specified sequence, to the extent that they are provided for in individual cases.

### BRIEF DESCRIPTION OF THE DRAWINGS

FIG. 1 is a collection of three flow diagrams illustrating steel process routes.

FIG. 2 is a collection of two flow diagrams illustrating process routes.

FIG. 3 is a two-page table showing possible manipulated variables sorted by production step.

### DETAILED DESCRIPTION

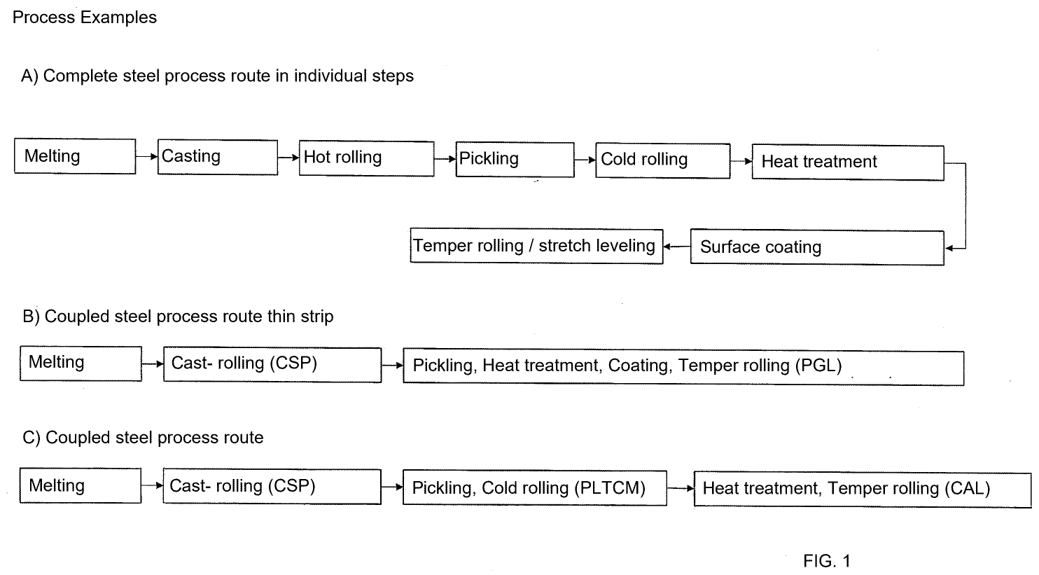

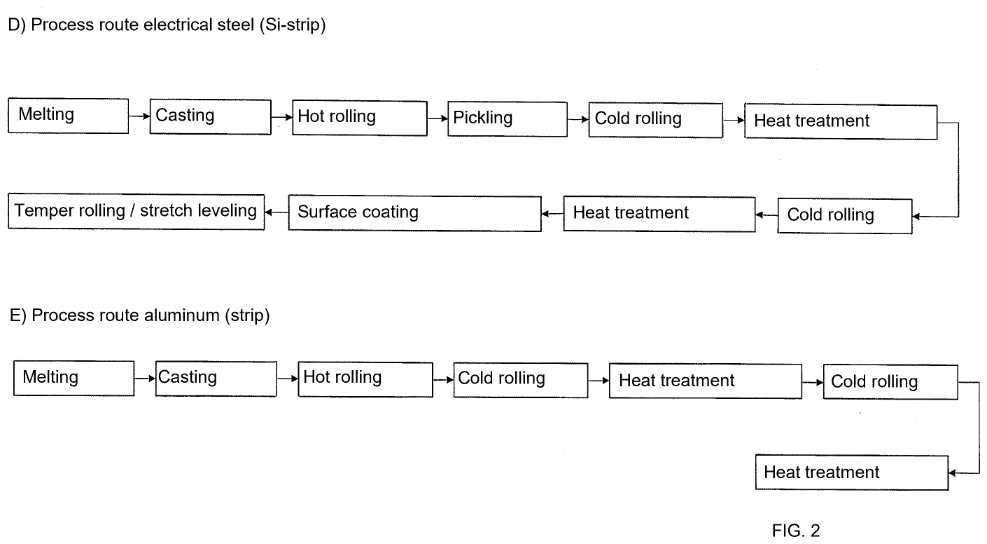

FIGS. 1 and 2 in each case show examples of different process routes with which different process steps are passed through one after the other to produce different metal products. Example A, for example, shows a complete steel process route in individual steps, with which all the process steps mentioned follow one another. Example B shows a coupled steel production route for the production of thin strip as a metal product. With this process route, the casting and rolling process steps in a CSP® (Compact Strip Production) plant and the pickling, heat treatment, surface coating and temper rolling process steps in a PGL (pickling and galvanizing line) plant are combined. A third exemplary embodiment shows a coupled steel process route with which the process steps of casting and rolling in a CSP® plant, the process steps of pickling and cold rolling in a PLTCM (coupled pickling line and tandem cold-rolling mill) plant and the process steps of heat treatment and temper rolling in a CAL (continuous annealing line) plant are in each case combined with one another. However, the claimed method can also be used accordingly for process routes for the production of a metal product not shown here.

FIG. 2 shows two further exemplary embodiments of possible process routes, for example process route D for the production of electrical steel strip, so-called “silicon strip,” as a metal product and, as exemplary embodiment E, an aluminum process route for the production of aluminum strip as the metal product.

Various possible measurement sites for measuring/determining the actual properties of the metal strip are presented below. As a function of the measurement site, possible process steps are specified, in which certain manipulated variables in each case can be suitably varied with regard to the desired target property. In this way, the process parameters for at least one of the plant components involved in the production process for a hot-rolled product are also optimized.

If the measurement site for one of the actual properties is located in the process step of melting, the manipulated variable for adjusting the actual property of the metal product can be selected from the set of manipulated variables that is assigned to one of the process steps that comes after the process step of melting, such as, for example, one of the process steps of casting, optionally including strand guiding, hot rolling, pickling, cold rolling, heat treatment, surface coating, temper rolling or stretch leveling.

If the measurement site for one of the actual properties is located in the process step of casting, preferably including strand guiding, the manipulated variable for adjusting the actual property of the metal product can be selected from the set of manipulated variables assigned to one of the process steps following the process step of casting, such as, for example, one of the process steps of hot rolling, pickling, cold rolling, heat treatment, surface coating, temper rolling or stretch leveling.

If the measurement site for one of the actual properties is located in the process step of hot rolling, the manipulated variable for adjusting the actual property of the metal product can be selected from the set of manipulated variables assigned to one of the process steps that comes after the process step of hot rolling, such as, for example, one of the process steps of pickling, cold rolling, heat treatment, surface coating, temper rolling or stretch leveling.

If the measurement site for one of the actual properties is located in the process step of pickling, the manipulated variable for adjusting the actual property of the metal product can be selected from the set of manipulated variables that is assigned to one of the process steps that comes after the process step of pickling, such as, for example, one of the process steps of cold rolling, heat treatment, surface coating, temper rolling or stretch leveling.

If the measurement site for one of the actual properties is located in the process step of cold rolling, the manipulated variable for adjusting the actual property of the metal product can be selected from the set of manipulated variables that follow the process step of cold rolling, such as, for example, one of the process steps of heat treatment, surface coating, temper rolling or stretch leveling.

If the measurement site for one of the actual properties is located in the process step of heat treatment, the manipulated variable for adjusting the actual property of the metal product can be selected from the set of manipulated variables that is assigned to one of the process steps that comes after the process step of heat treatment, such as, for example, one of the process steps of surface coating, temper rolling or stretch leveling.

If the measurement site for one of the actual properties is located in the process step of surface coating, the manipulated variable for adjusting the actual property of the metal product can be selected from the set of manipulated variables that is assigned to one of the process steps that comes after the process step of surface coating, such as, for example, one of the process steps of temper rolling or stretch leveling.

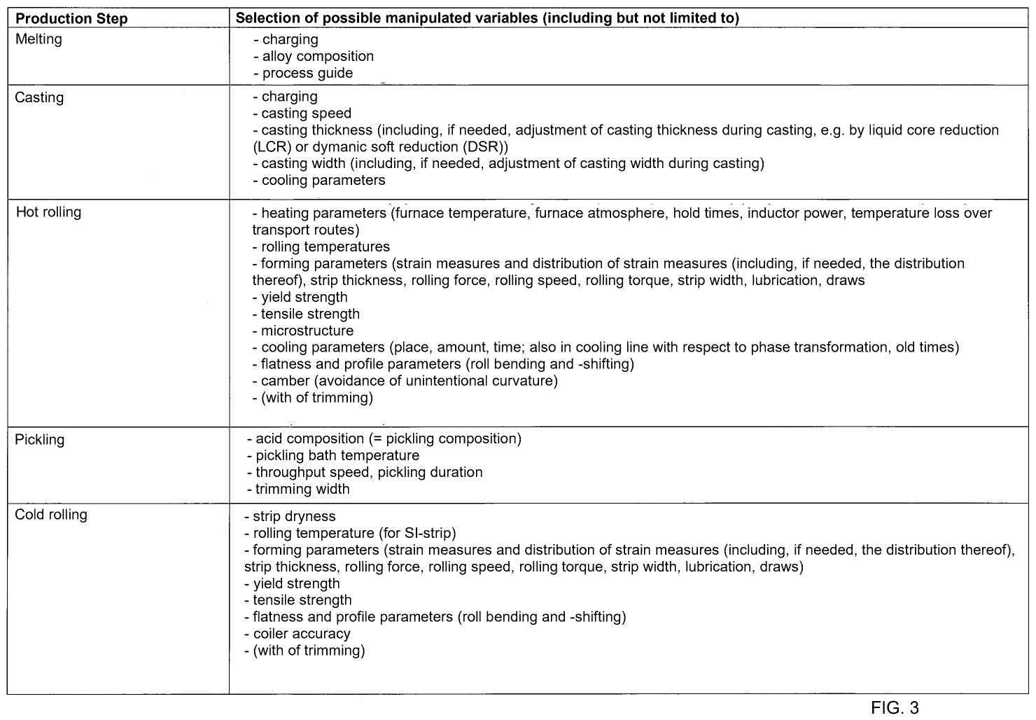

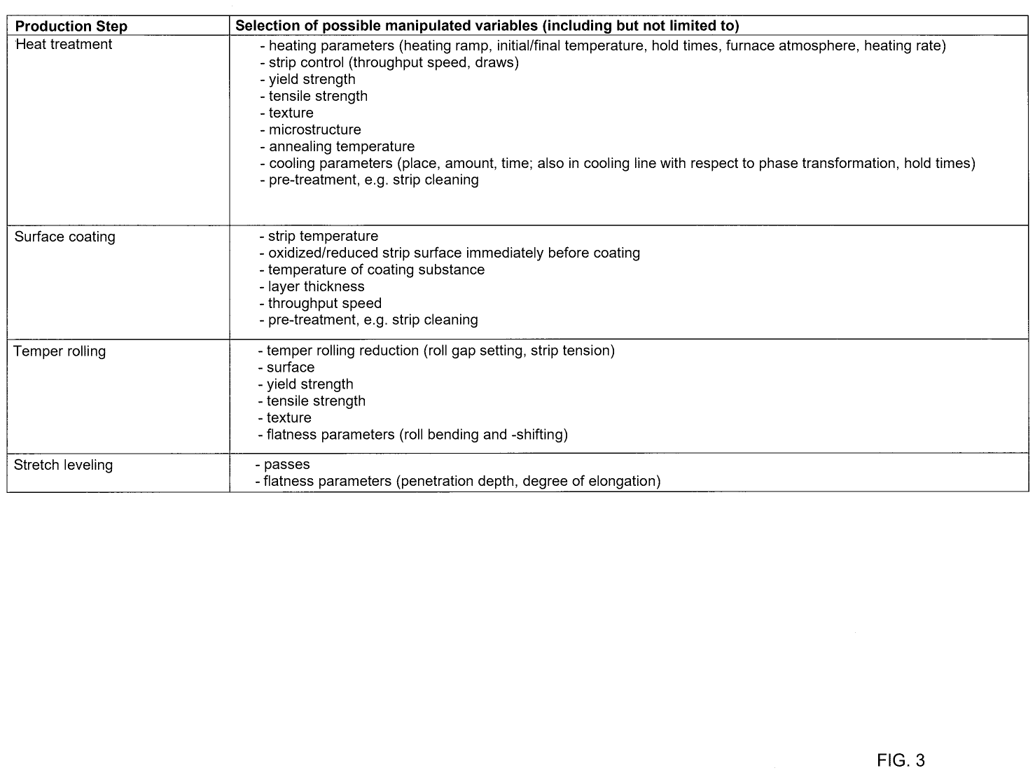

The manipulated variables preferably assigned to the individual process steps in each case are shown by way of example in the table in accordance with FIG. 3, pages 1 and 2, and/or the dependent claims. However, the claimed method can also be used accordingly for manipulated variables not shown here for the production of a metal product.

The method provides that at least one manipulated variable is suitably varied within the framework of the adjustment of the actual property to the target property of the metal strip. This manipulated variable must be selected from a process step that comes after the process step in which the measurement site for the actual property is located. In addition, further manipulated variables can be varied from any other process step, i.e. from the process step that corresponds to the process step to which the measurement site is assigned or is upstream or downstream of it.

In particular, a first manipulated variable for adjusting the actual properties of the metal product can be selected from a set of manipulated variables assigned to a first process step that comes after the process step to which the measurement site is assigned, and a second manipulated variable for adjusting the same actual properties of the metal product can be selected from a set of manipulated variables assigned to a second process step that comes after the first process step.

The variation of manipulated variables in a process step upstream of the process step with the measurement site offers the advantage that metal products to be produced in the future can be “saved” with regard to the desired target property, even if the metal products produced so far at the measurement site show a deviation between the actual and target property.

If the measurement site is located in the process step of “casting,” for example, the manipulated variable of “chemical composition of the melt” for a new product can be changed in accordance with the method so that the desired properties of the hot-rolled product are achieved at the target position (while maintaining the subsequent process control).

In another example, the mechanical properties to be achieved could also be attained if the process parameters for the casting process are changed by the method so that a microstructure more advantageous for setting the desired properties is produced, for example by means of a different temperature control during solidification in the strand. Here as well, for example, the process control can be retained during melting/in the downstream hot-rolling process.

The production steps can be, at least in part, partial production steps for producing the metal product as an intermediate product.

The manipulated variables can be calculated with the aid of a process model, for example within the framework of a simulation calculation, preferably in real time as set values for the actuators assigned in each case to the manipulated variables.

The adaptation of the process parameters just described for one plant component involved in the production of the hot-rolled product in each case can be effected in such a way that the remaining process control in the other plant components remains unchanged. The method in is able to predict the effect of the changes undertaken for a process step on the subsequent process steps and to make corresponding adaptations to the process parameters of these steps that are still to be undertaken. Accordingly, the method can also change the setting parameters for more than one plant component involved and predict the effects on the other plant models with the aid of the process models used, so that the desired mechanical properties can be set in the end product. The complexity increases accordingly the more variations are undertaken to the setting parameters.

1.-23. (canceled)

24. A method for producing a metal product in a plurality of successive process steps, each of the successive process steps having an assigned set of manipulated variables, the method comprising:
measuring an actual property of the metal product at a measurement site, at a beginning, during, or at an end of one but a last of the successive process steps, the last of the successive process steps being one in which the metal product is finished;
comparing the actual property of the metal product at the measurement site with a predefined target property of the metal product at an output of the last of the successive process steps;
determining an adjustment deviation; and
adjusting the actual property to the predefined target property by varying one of the manipulated variables,
wherein the one of the manipulated variables for adjusting the actual property of the metal product is selected from one of the assigned sets of manipulated variables that is assigned to one of the successive process steps that comes after the one but last of the successive process steps in which the measurement site is located.

25. The method according to claim 24,
wherein the actual property of the metal product is
an actual material property selected from the group consisting of a grain size, a microstructure, and a microstructural distribution of mixed microstructures, or
an actual strength property selected from the group consisting of a yield strength, a tensile strength, an elongation at break, and a uniform elongation, or
an actual geometric property selected from the group consisting of a flatness, a profile, a width, and a thickness.

26. The method according to claim 24,
wherein the successive process steps include one or more of melting, casting, hot rolling, pickling, cold rolling, heat treatment, surface coating, temper rolling, and stretch leveling.

27. The method according to claim 26,
wherein the measurement site is located in the process step of melting; and
wherein the one of the manipulated variables for adjusting the actual property of the metal product is selected from the set of manipulated variables that is assigned to one of the process steps that comes after the process step of melting, selected from the group consisting of casting, hot rolling, pickling, cold rolling, heat treatment, surface coating, temper rolling, and stretch leveling.

28. The method according to claim 26,
wherein the measurement site is located in the process step of casting; and
wherein the one of the manipulated variables for adjusting the actual property of the metal product is selected from the set of manipulated variables that is assigned to one of the process steps that comes after the process step of casting, selected from the group consisting of hot rolling, pickling, cold rolling, heat treatment, surface coating, temper rolling, and stretch leveling.

29. The method according to claim 26,
wherein the measurement site is located in the process step of hot rolling; and
wherein the one of the manipulated variables for adjusting the actual property of the metal product is selected from the set of manipulated variables that is assigned to one of the process steps that comes after the process step of hot rolling, selected from the group consisting of pickling, cold rolling, heat treatment, surface coating, temper rolling, and stretch leveling.

30. The method according to claim 26,
wherein the measurement site is located in the process step of pickling; and
wherein the one of the manipulated variables for adjusting the actual property of the metal product is selected from the set of manipulated variables that is assigned to one of the process steps that comes after the process step of pickling, selected from the group consisting of cold rolling, heat treatment, surface coating, temper rolling, and stretch leveling.

31. The method according to claim 26,
wherein the measurement site is located in the process step of cold rolling; and
wherein the one of the manipulated variables for adjusting the actual property of the metal product is selected from the set of manipulated variables that is assigned to one of the process steps that comes after the process step of cold rolling, selected from the group consisting of heat treatment, surface coating, temper rolling, and stretch leveling.

32. The method according to claim 26,
wherein the measurement site is located in the process step of heat treatment; and
wherein the one of the manipulated variables for adjusting the actual property of the metal product is selected from the set of manipulated variables that is assigned to one of the process steps that comes after the process step of heat treatment, selected from the group consisting of surface coating, temper rolling, and stretch leveling.

33. The method according to claim 26,
wherein the measurement site is located in the process step of surface coating; and
wherein the one of the manipulated variables for adjusting the actual property of the metal product is selected from the set of manipulated variables that is assigned to one of the process steps that comes after the process step of surface coating, selected from the group consisting of temper rolling and stretch leveling.

34. The method according to claim 26,
wherein the set of manipulated variables assigned to the process step of melting comprises charging, alloy composition, and process control.

35. The method according to claim 26,
wherein the set of manipulated variables assigned to the process step of casting comprises charging, casting speed, a casting thickness, adaptation of the casting thickness during casting via liquid core reduction (LCR) or via dynamic soft reduction (DSR), casting width, adaptation of the casting width during casting, and cooling parameters.

36. The method according to claim 26,
wherein the set of manipulated variables assigned to the process step of hot rolling comprises heating parameters, furnace temperatures, furnace atmospheres, holding times, inductor power, temperature losses over transport routes, rolling temperatures, forming parameters, degree of deformation, distribution of degrees of deformation, strip thickness, rolling force, rolling speed, rolling torque, strip width, lubrication, tensions, section limits, tensile strength, microstructure, cooling parameters, location of coolant application, coolant quantity, duration of cooling, holding times, flatness and profile parameters, roll bending, roll displacement, camber, edge curvature avoidance, and trimming width.

37. The method according to claim 26,
wherein the set of manipulated variables assigned to the process step of pickling comprises pickling duration, pickling bath temperature, pickling agent composition, throughput speed of the metal product, and trimming width.

38. The method according to claim 26,
wherein the set of manipulated variables assigned to the process step of cold rolling comprises strip dryness, rolling temperature, forming parameters, strip tension, degree of deformation, pass distribution, strip thickness, rolling speed, rolling force, roll gap lubrication conditions, strip tension, and trimming width.

39. The method according to claim 26,
wherein the set of manipulated variables assigned to the process step of heat treatment comprises heating parameters, heating speed, initial and final temperature, holding times, furnace atmosphere, heating rate, strip guiding parameters, throughput speed, tensions, yield strength, tensile strength, texture, microstructure, annealing temperature, cooling parameters, location of coolant application, coolant quantity, duration of cooling, coolant temperature, holding times, pre-treatment, and strip cleaning.

40. The method according to claim 26,
wherein the set of manipulated variables assigned to the process step of surface coating comprises strip temperature, oxidized or reduced strip surface immediately prior to coating, coating agent temperature, layer thickness, coating quality, throughput speed, pre-treatment, and strip cleaning.

41. The method according to claim 26,
wherein the set of manipulated variables assigned to the process step of temper rolling comprises degree of tempering, roll gap setting, strip tension, surface roughness, yield strength, tensile strength, texture, flatness parameters, roll bending and displacement.

42. The method according to claim 26,
wherein the set of manipulated variables assigned to the process step of stretch leveling comprises tensions, flatness parameters, immersion depth, and degree of stretch.

43. The method according to claim 24,
wherein a second manipulated variable for adjusting the actual property of the metal product is selected from a set of manipulated variables that is assigned to the one but last of the successive process steps to which the measurement site is assigned, or is upstream or downstream thereof.

44. The method according to claim 43,
wherein the one of the manipulated variables for adjusting the actual properties of the metal product is selected from a set of manipulated variables that is assigned to a first process step that comes after the one but last of the successive process steps to which the measurement site is assigned; and
wherein the second manipulated variable for adjusting the actual property of the metal product is selected from a set of manipulated variables that is assigned to a second process step that comes after the first process step.

45. The method according to claim 24,
wherein the one but the last of the successive process steps are partial production steps for producing the metal product as an intermediate product.

46. The method according to claim 24,
wherein the one of the manipulated variables is calculated with aid of a process model, within a framework of a simulation calculation, in real time as set values for one or more actuators assigned to the one of the manipulated variables.
